(19) United States
(12) Patent Application Publication
(10) Pub. No.: US 2025/0016839 A1
(43) Pub. Date: Jan. 9, 2025

(54) RESOURCES USAGE OPTIMIZATION

(71) Applicant: Nokia Technologies Oy, Espoo (FI)

(72) Inventors: Benoist Pierre SEBIRE, Tokyo (JP); Malgorzata TOMALA, Wroclaw (PL); Chunli WU, Beijing (CN)

(21) Appl. No.: 18/701,979

(22) PCT Filed: Oct. 21, 2021
(86) PCT No.: PCT/CN2021/125429

§ 371 Date: Apr. 17, 2024

(51) Int. Cl. H04W 74/0833; H04W 72/20

(52) U.S. Cl. CPC H04W 74/0833; H04W 72/20

(57) ABSTRACT

Embodiments of the present disclosure relate to devices. methods. apparatuses and computer-readable storage medium for resources usage optimization. In some example embodiments. from a first device. a second device receives a first set of indications of the first pool of resources for a first communication feature and a second set of indications of the second pool of resources for a second communication feature. The first set of indications is partially overlapping with the second set of indications when the first pool of resources is partially overlapping with the second pool of resources. The second device determines a random access resource based at least on a communication feature to be performed by the second device and the received first and second set of indications. The communication feature comprises at least one of the first communication feature and the second communication feature. The second device performs a random access using the determined random access resource.

### TECHNICAL FIELD

Embodiments of the present disclosure generally relate to the field of telecommunication, and in particular, to devices, methods, apparatuses and computer-readable storage media for resources usage optimization.

### BACKGROUND

With development of communication technology, terminal devices may initiate a random access procedure for performing a communication having different communication feature. For example, in different scenarios, a terminal device supporting communication features, such as, Coverage Enhancement (CE), Small Data Transmission (SDT), Reduced Capability (RedCap) and slicing may perform only CE communication, or only SDT communication, or only RD communication, or a combination communication of CE and SDT, or any other combination communication. Then, the terminal device should determine an appropriate random access channel resource for performing a certain communication feature with a radio access network device.

### SUMMARY

In general, example embodiments of the present disclosure provide devices, methods, apparatuses and computer-readable storage media for resources usage optimization.

In a first aspect, there is provided a first device. The first device comprises at least one processor and at least one memory including computer program code. The at least one memory and the computer program code configured to, with the at least one processor, cause the first device to reserve at least a first pool of resources for a first communication feature and a second pool of resources for a second communication feature. The first device is further caused to transmit, to a second device, a first set of indications of the first pool of resources and a second set of indications of the second pool of resources, wherein the first set of indications is partially overlapping with the second set of indications when the first pool of resources is partially overlapping with the second pool of resources.

In a second aspect, there is provided a second device. The second device comprises at least one processor and at least one memory including computer program code. The at least one memory and the computer program code configured to, with the at least one processor, cause the second device to, receive, from a first device, a first set of indications of the first pool of resources for a first communication feature and a second set of indications of the second pool of resources for a second communication feature, wherein the first set of indications is partially overlapping with the second set of indications when the first pool of resources is partially overlapping with the second pool of resources. The second device is further caused to determine a random access resource based at least on a communication feature to be performed by the second device and the received first and second set of indications, wherein the communication feature comprise at least one of the first communication feature and the second communication feature. The second device is further caused to perform a random access using the determined random access resource.

In a third aspect, there is provided a method implemented in a first device. In the method, the first device reserves at least a first pool of resources for a first communication feature and a second pool of resources for a second communication feature. The first device transmits, to a second device, a first set of indications of the first pool of resources and a second set of indications of the second pool of resources, wherein the first set of indications is partially overlapping with the second set of indications when the first pool of resources is partially overlapping with the second pool of resources.

In a fourth aspect, there is provided a method implemented in a second device. In the method, the second device receives, from a first device, a first set of indications of the first pool of resources for a first communication feature and a second set of indications of the second pool of resources for a second communication feature, wherein the first set of indications is partially overlapping with the second set of indications when the first pool of resources is partially overlapping with the second pool of resources. The second device determines a random access resource based at least on a communication feature to be performed by the second device and the received first and second set of indications, wherein the communication feature comprise at least one of the first communication feature and the second communication feature. The second device further performs a random access using the determined random access resource.

In a fifth aspect, there is provided an apparatus implemented in a first device. The apparatus comprises means for reserving at least a first pool of resources for a first communication feature and a second pool of resources for a second communication feature. The apparatus comprises means for transmitting, to a second device, a first set of indications of the first pool of resources and a second set of indications of the second pool of resources, wherein the first set of indications is partially overlapping with the second set of indications when the first pool of resources is partially overlapping with the second pool of resources.

In a sixth aspect, there is provided an apparatus implemented in a second device. The apparatus comprises means for receiving, from a first device, a first set of indications of the first pool of resources for a first communication feature and a second set of indications of the second pool of resources for a second communication feature, wherein the first set of indications is partially overlapping with the second set of indications when the first pool of resources is partially overlapping with the second pool of resources. The apparatus comprises means for determining a random access resource based at least on a communication feature to be performed by the second device and the received first and second sets of indications, wherein the communication feature comprise at least one of the first communication feature and the second communication feature; and means for performing a random access using the determined random access resource.

In an eighth aspect, there is provided computer-readable storage medium having instructions stored thereon. The instructions, when executed on at least one processor, cause the least one processor to perform the method to any of the three to fourth aspects.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example environment in which example embodiments of the present disclosure can be implemented;

FIG. 2 illustrates a signaling diagram for resource usage optimization in accordance with some embodiments of the present disclosure;

FIG. 3 illustrates example resource reservation in accordance with some embodiments of the present disclosure;

FIG. 4 illustrates an example relation of the pools of resources and the common resources in accordance with some embodiments of the present disclosure;

FIG. 5 illustrates a flowchart of an example method implemented at a first device in accordance with some embodiments of the present disclosure;

FIG. 6 illustrates a flowchart of an example method implemented at a second device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “radio access network device” or “RAN device” refers to a device which is capable of providing or hosting a cell or coverage where a second device, for example a terminal device, can communicate with. Examples of a first device include, but not limited to, a Node B (NodeB or NB), an Evolved NodeB (eNodeB or eNB), a next generation eNB (ng-eNB), a ng-eNB-Central Unit (ng-eNB-CU), a ng-eNB-Distributed Unit (ng-eNB-DU), a next generation NodeB (gNB), a gNB-Central Unit (gNB-CU), a gNB-Distributed Unit (gNB-DU), a Remote Radio Unit (RRU), a radio head (RH), a remote radio head (RRH), an Integrated Access and Backhaul (IAB) node, a low power node such as a femto node, a pico node, and the like. In some communication systems, the first device may consist of multiple separate entities, for example, in NTN system, the first device may be consist of radio frequency part located in satellites or drones, and inter-frequency/base band part located in ground stations.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Internet of Everything (IoE) devices, machine type communication (MTC) devices, device on vehicle for V2X communication where X means pedestrian, vehicle, or infrastructure/network, devices for Integrated Access and Backhaul (IAB), or image capture devices such as digital cameras, gaming devices, music storage and playback appliances, or Internet appliances enabling wireless or wired Internet access and browsing and the like. Herein, the term “terminal device” can be used interchangeably with a UE.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects.

As mentioned above, with the development of communication technology, for different communication requirements, different communication features are preconfigured in order to trade off communication requirements with limited resources. Further, random access channel (RACH) may be preconfigured for different communication features (such as, Small Data Transmission, Reduced Capability, Coverage Enhancements and Slicing), the pre-configuration aims to define a pool of resources to be used for a certain communication feature requiring dedicated resources to enable identification of the feature from the resources used. This would guarantee successful and fast access of the terminal devices to perform the certain communication feature, or guarantee the network to identify special treatment when providing the response e.g. with different uplink (UL) grant transport block size (TBS), with different repetitions etc. However, as the RACH resources are limited (64 preambles per RACH occasion), there may be a problem in signaling and identification of resources for the possible combinations of the communication features above. For example, Reduced capable terminal devices alone may use RACH resources dedicated to the Reduce Capability (RedCap), Coverage Enhancement capable terminal devices may use RACH resources dedicated to Coverage Enhancement (CE), Slice capable terminal devices may use RACH resources dedicated to Slice, but it is undefined how the terminal devices supporting two or more communication features (RedCap and CE, or RedCap, CE and Slicing, or other combinations of the communication features above) being configured simultaneously utilizes the allocated resources. At terminal device side, it is undefined how the terminal devices know about the overlapping resources that may be used for both one communication feature and another communication feature. In other words, at network side, it is undefined how the network learns that the terminal device initiating a random access procedure is to perform what communication feature.

There may be a solution for identifying the overlapping resources for combination communication type of the types of communication above. In this solution, RAN device may transmit individual signaling for each combination communication features. However, with the number of communication features increases, the number of signaling increases exponentially. Furthermore, strict isolation of the allocated resources per individual feature results in too scattered portions of resources, leading to adverse effect of collision or shortages in actual access.

Example embodiments of the present disclosure provide an efficient scheme to use the overlapping resources of RACH resources. In this scheme, a RAN device (which is also referred as “first device” in the following) reserves at least a first pool of resources for a first communication feature and a second pool of resources for a second communication feature different from the first communication feature. Then, the first device transmits a first set of indications of the first pool of resources and a second set of indications of the second pool of resources to a terminal device (which is also referred as “second device” in the following), wherein the first set of indications is partially overlapping with the second set of indications when the first pool of resources is partially overlapping with the second pool of resources. With the received first and second sets of indications, the second device may implicitly determine the first pool of resources dedicated to the first communication feature, and the portion in the first pool of resources overlapping with the second pool of resources (if the overlapping exists).

In this way, the second device is able to determine the RACH resources for performing a combination communication having the first and second communication features without receiving a separate signaling for each combination of communication features. On the other side, the first device may identify special treatment for a second device in the case of the first device receives a preamble on a certain RACH resource (for example, overlapping portion of the pool of the resources) from the second device.

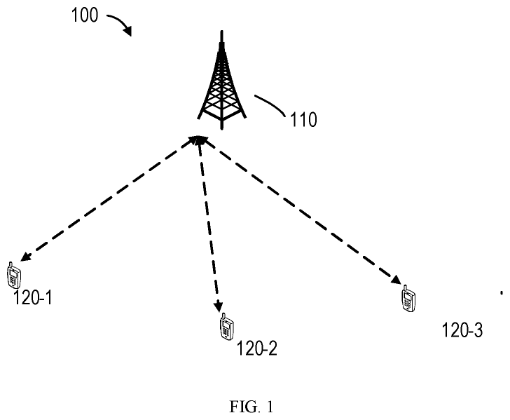

With reference to FIGS. 1-7, example embodiments according to the present disclosure for resources usage optimization are described.

FIG. 1 illustrates an example environment 100 in which example embodiments of the present disclosure can be implemented.

The environment 100, which may be a part of a communication network, comprises a first device 110 (operating as a RAN device) as well as a second device 120-1, second device 120-2, second device 120-3. For sake of discussion, the terminal device 120-1, terminal device 120-2 and a terminal device 120-3 may be collectively referred to as “second device 120” (operating as a terminal device). The second device 120 may communicate with the first device 110.

It is to be understood that the number of second devices and first devices is shown in the environment 100 only for the purpose of illustration, without suggesting any limitation to the scope of the present disclosure. In some embodiments, the environment 100 may comprise a further second device to communicate information with a further first device.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

In the environment 100, the second device 120 is able to support combination communication features being configured simultaneously. For example, the second device 120 is able to support the combination of SDT and RD being configured simultaneously. Whether to perform a random access for the combination of the communication features is based on the communication requirement of the second device 120 or network capabilities, etc. The second device should first determine RACH resource for the combination of the communication features when it determines to perform communication having combination communication features.

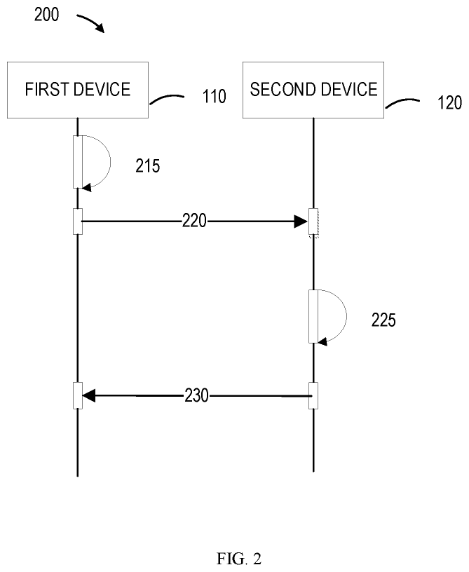

FIG. 2 illustrates a signaling diagram 200 for resources usage optimization in accordance with some embodiments of the present disclosure. For the purpose of discussion, the signaling diagram 200 will be described with reference to FIG. 1.

In the signaling diagram 200, the first device 110 reserves (215) at least a first pool

of resources for a first communication feature and a second pool of resources for a second communication feature. In some embodiments, the first and second pools of resources comprise at least one physical random access resource (for example, at least one physical random access occasion) in a time domain and/or a frequency domain, and/or at least one preamble for a random access (for example, a preamble in a physical random access occasion for a random access). In some embodiments, the first and second pools of resources also comprise any other type of shared resources, for example, Configured Grant Type. For sake of discussion, the resource in the following refers to PRACH for random access and/or preambles on PRACH. The first and second communication features may be any communication feature which is defined or undefined already. For example, the first and second communication feature may be at least one of: CE, SDT, RedCap and Slicing. In some embodiments, the communication features may comprise other features defined in the future.

Then, the first device 110 transmits (220) a first set of indications of the first pool of resources and a second set of indications of the second pool of resources to the second device 120. In some embodiments, the first pool of resources partially overlaps with the second pool of resources. In this case, the first set of indications is partially overlapping with the second set of indications. For example, the first set of indications comprises the indexes of resources in the first pool of resources and the second set of indications comprises the indexes the resources in the second pool of resources. In this way, the first set of indications partially overlaps with the second set of indications when the first pool of resources partially overlaps with the second pool of resources. In an exemplary embodiment, assuming that the first pool of resources “PRACH 1-5” are reserved for the first communication feature, and the second pool of resources “PRACH 3-10” are reserved for the second communication feature, thereby the indications of the resources PRACH 3-5 in the first pool of resources overlap with the indications of the resources PRACH 3-5 in the second pool of resources.

In some embodiments, the associations between the pools of resources and the communication features may be determined by the second device 120 with preconfigured rules. For example, the set of indications are ordered in a preconfigured sequence. It is to be understood that there may be any other rules for determining the associations between the pools of resources and the communication features by the second device 120.

Alternatively or in addition, in some embodiments, the first device 110 also transmits a first indication of a first association between the first pool of resources and the first communication feature and a second indication of a second association between the second pool of resources and the second communication feature to the second device 120. As such, the second device 120 may determine the resources dedicated to a certain communication feature with this indication.

Alternatively or in addition, in some embodiments, the first device 110 also transmits an explicit indication (referred as a third indication in the following) whether the first pool of resources overlaps with the second pool of resources. For example, along with the first set of indications of the first pool of resources, the first device 110 also transmits a third indication of the resources in the first pool of resources overlapping with the second pool of resources.

With these sets of indications, the second device 120 may implicitly determine (225) the overlapping resources for a random access of combination communication having the first and second communication features. Returning to the above example with respect to the set of indexes “PRACH 1-10”, as the “PRACH 3-5” are overlapping resources, the second device 120 may determine the “PRACH 3-5” as the resource for combination communication having the first and second communication features. If the second device 120 is to perform a combination communication having the first and second communication features, the second device 120 may transmit a preamble on the PRACH 3-5 to initiate a random access. Otherwise, if the second device 120 is to perform the first communication feature, the second device may transmit a preamble on the PRACH 1-2 to initiate a random access.

Alternatively or in addition, the second device 120 may also determine (225) the overlapping resources for a random access of combination communication having the first and second communication features based on the first set of indications and the third indication.

After determining the resource for the random access for the communication feature to be performed by the second device 120, the second device 120 performs (230) a random access using the determined random access resource. For example, the second device 120 may transmit the preamble on the determined random access resource to the first device 110.

At the first device 110 side, in some embodiments, if receiving a preamble for a random access from the second device 120 on a non-overlapping resource in the first pool of resources, the first device 110 may understand that communication to be performed by the second device has the first communication feature. In some embodiments, if receiving the preamble for the random access from the second device 120 on an overlapping resource in the first pool of resources, the first device 110 may understand that communication to be performed by the second device has a combination of the first and second communication features.

In this way, with the reservation of the first and second pools of the resources and the first and second sets of indications, terminal devices (second device) may implicitly determine the appropriate RACH resource for any communication feature or any combination of communication features. At the RAN device (first device) side, RAN device can provide special treatment based on the preamble received from the terminal Thereby, the signaling overhead is minimized. Furthermore, if new device. communication features are added, the number of sets of indications is increased linearly rather than being increased exponentially. Therefore, this mechanism has capability of forward compatible.

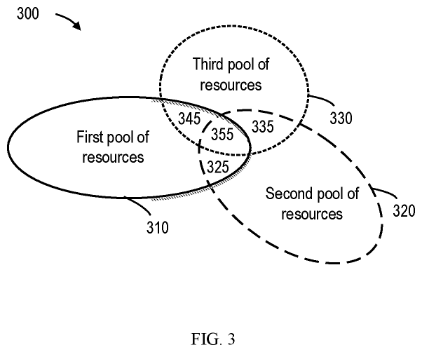

FIG. 3 illustrates example resource reservation 300 in accordance with some embodiments of the present disclosure. For the purpose of discussion, the partition 300 will be described with reference to FIG. 1.

In this example, the first device 110 reserves a first pool 310 of resources for a first communication feature and a second pool 320 of resources for a second communication feature. In some embodiments, the first device 110 further reserves a third pool 330 of resources for a third communication feature. It is to be understood that the number of communication features and the corresponding pools of the resources is just an example, the first device 110 may also reserve other pools of resources for other communication features. In some embodiments, the first communication feature may be CE, the second communication feature may be RedCap and the third communication feature may be SDT. In some embodiments, as mentioned above, there may be another communication feature which being defined already (for example, slicing) or not.

The first, second and third pools 310, 320 and 330 of resources overlap with each other. In some embodiments, the first pool 310 of resources may only overlap with the second pool 320 of resources or only overlap with the third pool 230 of resources. In some embodiments, the second pool 220 of resources may only overlap with the third pool 330 of resources. Moreover, in some embodiments, the first, second and third pools 310, 320 and 330 do not overlap with each other.

In some embodiments, the pools of resources comprise at least one physical random access channel resource in a time and/or a frequency domain and/or at least one preamble for a random access. In this case, the resources in the pool of resources may be used by a second device 120 for initiating a random access. In some embodiments, the pools of resources comprise Configured Grant Type.

For sake of discussion, the following embodiments are described in the situation that the resources in pools of resources refer to the random access resources (for example, random access occasions in time domain and/or frequency domain) and/or the preambles. In the implementation of the resource reservation 300, resources in the first overlapping 325 between the first pool of resources 310 and the second pool of resources 320 may be used for a second device 120 to perform a random access having the first communication feature and the second communication feature. Similarly, resources in the second overlapping 335 may be used for the second device 120 to perform a random access having the second communication feature and the third communication feature. Resources in the third overlapping 345 may be used for the second device 120 to perform a random access having the first communication feature and the third communication feature. Resources in the fourth overlapping 355 may be used for the second device 120 to perform a random access having the first, second and third communication features.

As such, the first device 110 may provide respective response to the second device

120 when the second device 120 performs a random access using certain pool of resources. For example, the second device 120 transmits the preamble on the certain pool of resources to the first device 110. In other words, the first device understands the communication feature to be performed by the second device 120.

After the reservation of the first, second and third pools of resources, the first device 110 transmits a first set of indications of the first pool of resources, a second set of indications of the second pool of resources and a third set of indications of the third pool of resources. In this way, the possible overlaps across the pools (for different features) are not explicitly signaled, but the possible overlaps across the pools can be implicitly obtained from the above sets of indications. For example, the possible overlapping resources are excluded from each pool of resources for individual communication feature, when the second device 120 is not to perform a random access for a combination of multiple communication features.

At the first device 110 side, the communication feature to be performed by the second device 120 can be determined based on received preamble from the second device 120. For example, if the preamble received is on the resource in the first pool of resources which not overlaps with other pools of resources, the communication feature to be performed by the second device 120 can be determined as the first communication. If the preamble received is on the resource (for example, on the overlapping resource portion 355) in the first pool of resources which overlaps with the second and third pools of resources, the communication feature to be performed by the second device 120 can be determined as a combination of the first, second and third communication features.

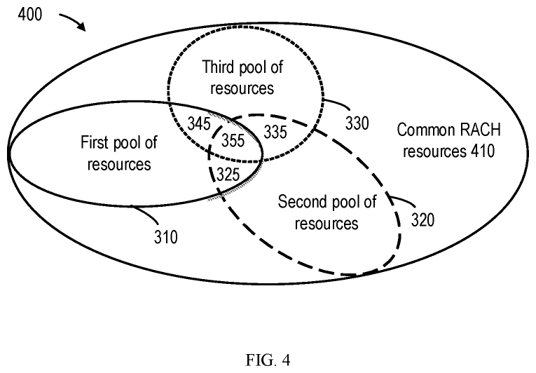

FIG. 4 illustrates an example relation 400 of the pools of resources and the common resources in accordance with some embodiments of the present disclosure.

As shown in FIG. 4, a first pool 310 of resources is reserved for a first communication feature, a second pool 320 of resources is reserved for a second communication feature and a third pool 330 of resources is reserved for a third communication feature. In some embodiments, the first communication feature may be Coverage Enhancement (CE), the second communication may be Small Data Transmission (SDT) and the third communication may be Reduced Capability (RedCap).

The RACH resources for combination communication having multiple individual communication features are implicitly indicated to the terminal devices through the above three pools. For example, the resources reserved for a Combination of first and third communication features are in the third overlapping 345; the resource reserved for a reserved for a Combination of first and second communication features are in the first overlapping 325; and the resources reserved for a Combination of the second and third communication features are in the second overlapping 335. Further, the resources reserved for a Combination of first, second and third communication features are in the fourth overlapping 355.

In this way, once the sets of indications of the first, second and third pools of resources are transmitted to the second device 120, the second device 120 can determine each partition of resources by comparing the sets of indications. To help the UE in comparing the pools, the first set of indications of the first pool 310 of resources may be accompanied by an indication of overlapping, and/or the second set of indications of the second pool 320 of resources and the third set 330 of indications of the third pool of resources.

Moreover, the second set of indications of the second pool 320 of resources may be accompanied by an indication of overlapping, and/or the first set of indications of the first 310 pool of resources and the third set of indications of the third pool 330 of resources. The third set of indications of the third pool 330 of resources may be accompanied by an indication of overlapping, and/or the first set of indications of the first pool 310 of resources and the second set of indications of the second 320 pool of resources.

From these sets of indications, the second device 120 can conclude that:
the resources in the first pool 310 of resources which not overlaps with other pools of the resources are reserved for the second device 120 performing the first communication feature only;
the resources in the second pool 320 of resources which not overlaps with other pools of the resources are reserved for the second device 120 performing the second communication feature only;
the resources in the second pool 330 of resources which not overlaps with other pools of the resources are reserved for the second device 120 performing the third communication feature only;
the resources in the first overlapping 325 are reserved for the second device 120 performing random access for a combination of the first and second communication features;
the resources in the second overlapping 335 are reserved for the second device 120 performing random access for a combination of the second and third communication features;
the resources in the third overlapping 345 are reserved for the second device 120 performing random access for a combination of the first and third communication features;
the resources in the fourth overlapping 345 are reserved for the second device 120 performing random access for a combination of the first, second and third communication features; and.
The common RACH resources 410 apart from those above are reserved for the second device 120 performing random access for none of these features.

Alternatively or in addition, in some embodiments, a separate signaling then links each communication feature to an actual feature, such as, first communication feature—CE, second communication feature-RedCap and third communication feature—SDT.

Then, the area is determined by the second device 120 based on acquired first device 110 signaling. The configuration of the first device 110 for individual RACH resources indicates the pools of Random Access resources separately from the total numer of preambles used in a cell:
a first pool 310 of resources is reserved for a first communication feature (for example, CE);
a second pool 320 of resources is reserved for a second communication feature (for example RedCap); and
a third pool 330 of resources is reserved for a third communication feature (for example, SDT).

Then, the second device 120′s behavior is further determined by the second device 120 capability:
If the second device 120 supports all three features and the second device 120 is to perform non-SDT access but the UE is not in enhanced coverage—the second device 120 shall determine a resource in the second pool 320 which not overlaps with other pools of resources;
If the second device 120 supports all three communication features and the second device 120 is to perform SDT access but the second device 120 is not in enhanced coverage—the second device 120 shall determine a resource in the second overlapping 335;
if the second device 120 supports all three features and the second device 120 is to perform SDT access and the second device 120 is in enhanced coverage-the second device 120 determine a preamble in the fourth overlapping 355,.
if the second device 120 is not supporting any of the features or when not performing RA for the new features, the second device 120 selects Commonly available RACH Configuration Occasion in common RACH resources 410.

In some embodiments, the RACH resources can be split into different pools by using different periodicities and different RACH occasions.

In this way, the signaling overhead is minimized, and a new feature in a later release can be smoothly introduced because legacy terminal devices only need to understand that a pool for a new feature is introduced, exclude the corresponding resources and need not understand the actual feature. Also pools for existing features need not to be reconfigured, the new portions to exclude can be obtained from the added pools.

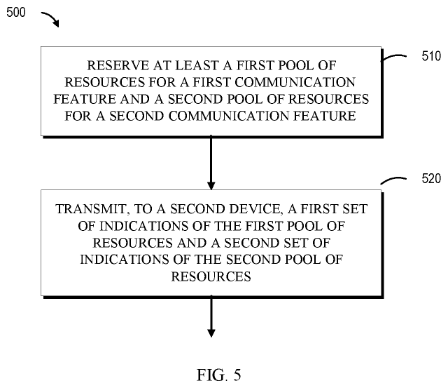

FIG. 5 illustrates a flowchart of an example method 500 implemented at a first device in accordance with some embodiments of the present disclosure. For the purpose of discussion, the method 500 will be described with reference to FIG. 1. It is to be understood that the method 500 may include additional acts not shown and/or may omit some shown acts, and the scope of the present disclosure is not limited in this regard.

At block 510, the first device 110 reserves at least a first pool of resources for a first communication feature and a second pool of resources for a second communication feature.

At block 520, the first device 110 transmits, to a second device 120, a first set of indications of the first pool of resources and a second set of indications of the second pool of resources, wherein the first set of indications is partially overlapping with the second of indications when the first pool of resources is partially overlapping with the second pool of resources.

In some embodiments, the first device 110 transmits to the second device, a first indication of a first association between the first pool of resources and the first communication feature and a second indication of a second association between the second pool of resources and the second communication feature.

In some embodiments, the first device 110 transmits, to the second device, a third indication whether the first pool of resources overlaps with the second pool of resources.

In some embodiments, wherein the first pool of resources overlaps with the second pool of resources, in response to receiving a preamble for a random access from the second device 120 on a non-overlapping resource in the first pool of resources, the first device 110 determines that communication to be performed by the second device has the first communication feature; and/or in response to receiving the preamble for the random access from the second device 120 on an overlapping resource in the first pool of resources, the first device 110 determines that the communication to be performed by the second device has a combination of the first and second communication features.

In some embodiments, the first and second pools of resources comprise at least one physical random access channel resource in a time and/or a frequency domain and/or at least one preamble for a random access occasion.

In some embodiments, at least one of the first and second communication features comprises at least one of Coverage Enhancement (CE), Small Data Transmission (SDT), Reduced Capability (RedCap) or slicing.

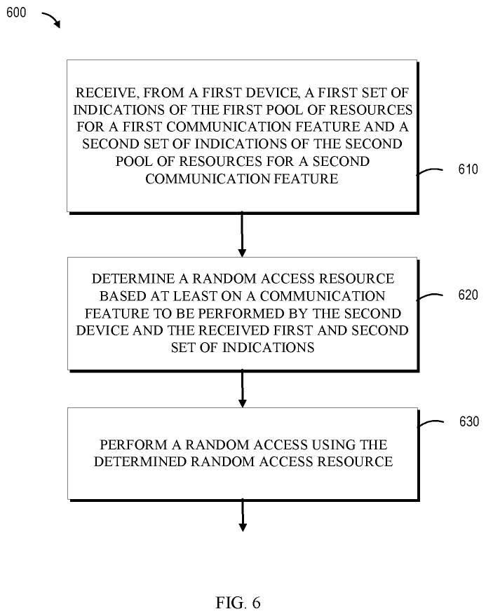

FIG. 6 illustrates a flowchart of an example method 600 implemented at a second device 120 in accordance with some embodiments of the present disclosure. For the purpose of discussion, the method 600 will be described with reference to FIG. 1. It is to be understood that the method 600 may include additional acts not shown and/or may omit some shown acts, and the scope of the present disclosure is not limited in this regard.

At block 610, the second device 120 receives, from a first device 110, a first set of indications of the first pool of resources for a first communication feature and a second set of indications of the second pool of resources for a second communication feature, wherein the first set of indications is partially overlapping with the second of indications when the first pool of resources is partially overlapping with the second pool of resources.

At block 620, the second device 120 determines a random access resource based at least on a communication feature to be performed by the second device and the received first and second set of indications, wherein the communication feature comprise at least one of the first communication feature and the second communication feature.

At block 630, the second device 120 performs a random access using the determined random access resource.

In some embodiments, the second device 120 receives, from the first device 110, a first indication of a first association between the first pool of resources and the first communication feature and a second indication of a second association between the second pool of resources and the second communication feature.

In some embodiments, the second device 120 receives, from the first device 110, a third indication whether the first pool of resources overlaps with the second pool of resources.

In some embodiments, the first pool of resources overlaps with the second pool of resources, the method 600 further comprises based on at least one of the received first and second sets of indications, the received first and the second indications, and the received third indication, in accordance with determination that the second device 120 is to perform the first communication feature, the second device determines the preamble on a non-overlapping resource in the first pool of resources as the determined random access resource; or in accordance with determination that the second device 120 is to perform both the first and second communication features, the second device 120 determines the preamble on an overlapping resource in the first pool of resources as the determined random access resource.

In some embodiments, the method 600 further comprises based on at least one of the received first and second sets of indications, in accordance with determination that the second device 120 is to perform another communication feature other than the first and second communication features, the second device 120 determines the preamble in common resources other than the first and second pools of resources as the determined random access resource.

In some embodiments, the first and second pools of resources comprise at least one physical random access resource in a time and/or a frequency domain and/or at least one preamble for a random access.

In some embodiments, at least one of the first and second communication features comprises at least one of Coverage Enhancement (CE), Small Data Transmission (SDT), Reduced Capability (RedCap) or slicing.

In some aspects, an apparatus implemented in a first device comprises: means for reserving at least a first pool of resources for a first communication feature and a second pool of resources for a second communication feature; and means for transmitting, to a second device, a first set of indications of the first pool of resources and a second set of indications of the second pool of resources, wherein the first set of indications is partially overlapping with the second of indications when the first pool of resources is partially overlapping with the second pool of resources.

In some aspects, an apparatus implemented in a second device comprises: means for receiving, from a first device, a first set of indications of the first pool of resources for a first communication feature and a second set of indications of the second pool of resources for a second communication feature, wherein the first set of indications is partially overlapping with the second set of indications when the first pool of resources is partially overlapping with the second pool of resources; means for determining a preamble based on a communication feature to be performed by the second device and the received first and second set of indications, wherein the communication feature comprise at least one of the first communication feature and the second communication feature and means for transmitting a preamble on the determine resource to the first device for a random access.

In some aspects, a first device comprises at least one processor; and at least one memory including computer program code; and the at least one memory and the computer program code configured to, with the at least one processor, cause the first device to: reserve at least a first pool of resources for a first communication feature and a second pool of resources for a second communication feature; and transmit, to a second device, a first set of indications of the first pool of resources and a second set of indications of the second pool of resources, wherein the first set of indications is partially overlapping with the second set of indications when the first pool of resources is partially overlapping with the second pool of resources.

In some aspects, a second device comprises at least one processor; and at least one memory including computer program code; the at least one memory and the computer program code configured to, with the at least one processor, cause the second device to: receive, from a first device, a first set of indications of the first pool of resources for a first communication feature and a second set of indications of the second pool of resources for a second communication feature, wherein the first set of indications is partially overlapping with the second of indications when the first pool of resources is partially overlapping with the second pool of resources; determine a random access resource based at least on a communication feature to be performed by the second device and the received first and second set of indications, wherein the communication feature comprise at least one of the first communication feature and the second communication feature; and perform a random access using the determined random access resource.

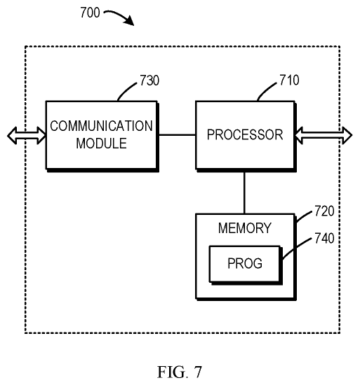

FIG. 7 is a simplified block diagram of a device 700 that is suitable for implementing example embodiments of the present disclosure. The device 700 can be implemented at the first device 210, the second device 220 or the third device 230 as shown in FIG. 2.

As shown, the device 700 includes a processor 710, a memory 720 coupled to the processor 710, a communication module 730 coupled to the processor 710, and a communication interface (not shown) coupled to the communication module 730. The memory 720 stores at least a program 740. The communication module 730 is for bidirectional communications, for example, via multiple antennas or via a cable. The communication interface may represent any interface that is necessary for communication.

The program 740 is assumed to include program instructions that, when executed by the associated processor 710, enable the device 700 to operate in accordance with the example embodiments of the present disclosure, as discussed herein with reference to FIGS. 1 to 6. The example embodiments herein may be implemented by computer software executable by the processor 710 of the device 700, or by hardware, or by a combination of software and hardware. The processor 710 may be configured to implement various example embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700.

The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

When the device 700 acts as the first device 110, the processor 710 may implement the operations or acts of the first device 110 as described above with reference to FIGS. 2 and 5. When the device 700 acts as the second device 120, the processor 710 may implement the operations or acts of the second device 120 as described above with reference to FIGS. 2 and 6. All operations and features as described above with reference to FIGS. 1 to 6 are likewise applicable to the device 700 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the operations and acts as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable In certain circumstances, multitasking and parallel processing may be results. advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

What is claimed is:

1. A first device, comprising:
at least one processor; and
at least one memory including computer program code;
the at least one memory and the computer program code configured to, with the at least one processor, cause the first device to:
reserve at least a first pool of resources for a first communication feature and a second pool of resources for a second communication feature; and
transmit, to a second device, a first set of indications of the first pool of resources and a second set of indications of the second pool of resources, wherein the first set of indications is partially overlapping with the second set of indications when the first pool of resources is partially overlapping with the second pool of resources.

2. The first device of claim 1, wherein the at least one memory and the computer program code are further configured to, with the at least one processor, cause the first device to:
transmit, to the second device, a first indication of a first association between the first pool of resources and the first communication feature and a second indication of a second association between the second pool of resources and the second communication feature.

3. The first device of claim 1, wherein the at least one memory and the computer program code are further configured to, with the at least one processor, cause the first device to:
transmit, to the second device, a third indication whether the first pool of resources overlaps with the second pool of resources.

4. The first device of claim 1, wherein the first pool of resources overlaps with the second pool of resources, and the at least one memory and the computer program code are further configured to, with the at least one processor, cause the first device to:
in response to receiving a preamble for a random access from the second device on a non-overlapping resource in the first pool of resources, determine that communication to be performed by the second device has the first communication feature, and/or
in response to receiving the preamble for the random access from the second device on an overlapping resource in the first pool of resources, determine that the communication to be performed by the second device has a combination of the first and second communication features.

5. The first device of claim 1, wherein the first and second pools of resources comprises at least one physical random access channel resource in a time and/or a frequency domain and/or at least one preamble for a random access.

6. The first device of claim 1, wherein at least one of the first and second communication features comprises at least one of:
Coverage Enhancement (CE), Small Data Transmission (SDT), Reduced Capability (RedCap) or slicing.

7. A second device, comprising:
at least one processor; and
at least one memory including computer program code;
the at least one memory and the computer program code configured to, with the at least one processor, cause the second device to:
receive, from a first device, a first set of indications of the first pool of resources for a first communication feature and a second set of indications of the second pool of resources for a second communication feature, wherein the first set of indications is partially overlapping with the second of indications when the first pool of resources is partially overlapping with the second pool of resources;
determine a random access resource based at least on a communication feature to be performed by the second device and the received first and second set of indications, wherein the communication feature comprises at least one of the first communication feature and the second communication feature; and
perform a random access using the determined random access resource.

8. The second device of claim 7, wherein the at least one memory and the computer program code are further configured to, with the at least one processor, cause the second device to:
receive, from the first device, a first indication of a first association between the first pool of resources and the first communication feature, and a second indication of a second association between the second pool of resources and the second communication feature.

9. The second device of claim 7, wherein the at least one memory and the computer program code are further configured to, with the at least one processor, cause the second device to:
receive, from the first device, a third indication whether the first pool of resources overlaps with the second pool of resources.

10. The second device of claim 8, wherein the first pool of resources overlaps with the second pool of resources, and the at least one memory and the computer program code are further configured to, with the at least one processor, cause the second device to:
based on at least one of following:
the received first and second sets of indications,
the received first and the second indications, and
the received third indication,
in accordance with determination that the second device is to perform the first communication feature, determine the random access resource on a non-overlapping resource in the first pool of resources as the determined random access resource; or
in accordance with determination that the second device is to perform both the first and second communication features, determine the random access resource on an overlapping resource in the first pool of resources as the determined random access resource.

11. The second device of claim 9, wherein the at least one memory and the computer program code are further configured to, with the at least one processor, cause the second device to:
based on at least one of following:
the received first and second sets of indications,
the received first and the second indications, and
the received third indication,
in accordance with determination that the second device is to perform another communication feature other than the first and second communication features, determine the random access resource in common resources other than the first and second pools of resources as the determined random access resource.

12. The second device of claim 7, wherein the first and second pools of resources comprises at least one physical random access channel resource in a time and/or a frequency domain and/or at least one preamble for the random access.

13. The second device of claim 7, wherein at least one of the first and second communication features comprises at least one of:
Coverage Enhancement (CE), Small Data Transmission (SDT), Reduced Capability (RedCap) or slicing.

14-19. (canceled)

20. A method implemented in a second device, comprising:
receiving, from a first device, a first set of indications of the first pool of resources for a first communication feature and a second set of indications of the second pool of resources for a second communication feature, wherein the first set of indications is partially overlapping with the second set of indications when the first pool of resources is partially overlapping with the second pool of resources;
determining a random access resource based at least on a communication feature to be performed by the second device and the received first and second set of indications, wherein the communication feature comprise at least one of the first communication feature and the second communication feature; and
performing a random access using the determined random access resource.

21. The method of claim 20, further comprises:
receiving, from the first device, a first indication of a first association between the first pool of resources and the first communication feature and a second indication of a second association between the second pool of resources and the second communication feature.

22. The method of claim 20, further comprises:
receiving, from the first device, a third indication whether the first pool of resources overlaps with the second pool of resources.

23. The method of claim 20, wherein the first pool of resources overlaps with the second pool of resources, the method further comprises:
based on at least one of following:
the received first and second sets of indications,
the received first and the second indications, and
the received third indication,
in accordance with determination that the second device is to perform the first communication feature, determining the random access resource on a non-overlapping resource in the first pool of resources as the determined random access resource; or
in accordance with determination that the second device is to perform both the first and second communication features, determining the random access resource on an overlapping resource in the first pool of resources as the determined random access resource.

24. The method of claim 20, further comprises:
based on at least one of following:
the received first and second sets of indications,
the received first and the second indications, and
the received third indication,
in accordance with determination that the second device is to perform another communication feature other than the first and second communication features, determining the random access resource in common resources other than the first and second pools of resources as the determined random access resource.

25. The method of claim 20, wherein the first pool of resources comprises at least one physical random access channel resource in a time and/or a frequency domain and/or at least one preamble for a random access.

26. The method of claim 20, wherein at least one of the first and second communication features comprises at least one of:
Coverage Enhancement (CE), Small Data Transmission (SDT), Reduced Capability (RedCap) or slicing.

27-29. (canceled)
